(19) United States
(12) Patent Application Publication
(10) Pub. No.: US 2024/0320752 A1
(43) Pub. Date: Sep. 26, 2024

(54) DATA INTEGRATION AND STANDARDIZATION OF UNDERWRITING INFORMATION FOR GENERATING PRODUCT AND COVERAGE RECOMMENDATIONS IN A MULTI-CARRIER ENVIRONMENT

(71) Applicant: MYLO, LLC, Kansas City, MO (US)

(72) Inventors: Belen TOKARSKI, Kansas City, MO (US); David Embry, Kansas City, MO (US); Gregory Bannon, Kansas City, MO (US); Chloe Segale, Kansas City, MO (US)

(21) Appl. No.: 18/732,447

(22) Filed: Jun. 3, 2024

Related U.S. Application Data
(63) Continuation-in-part of application No. 16/698,663, filed on Nov. 27, 2019.

(51) Int. Cl. G06Q 40/08; G06Q 30/0601

(52) U.S. Cl. CPC G06Q 40/08; G06Q 30/0631; G06Q 30/0609

(57) ABSTRACT

Systems and methods are disclosed for dynamically adjusting user-specific underwriting information when determining a product and coverage recommendations for mitigating a likelihood of occurrence of adverse incidents. The method includes generating a set of master question answers based on underwriting information associated with a plurality of carriers and a user-specific set of question answers by mapping underwriting information associated with the plurality of carriers determined to provide carrier-specific products and coverages to the second set of carrier-specific question answers. The plurality of carriers may be adjusted based on user provided responses to the user-specific set of question answers, which may be adjusted in parallel.

### RELATED APPLICATIONS

This application a continuation-in-part of U.S. patent application Ser. No. 16/698,663, filed on Nov. 27, 2019, the contents of which are incorporated herein by reference in its entirety.

### TECHNICAL FIELD

The present disclosure is generally related to insurance. More particularly, the present disclosure is directed to systems and methods for determining insurance coverage needs of a user based on a likelihood of actually using the coverage.

### BACKGROUND

Insurance selection, regardless of the type of coverage, is usually based on determining what coverage one may need. For example, when selecting a health insurance policy, a person may do so by estimating a likelihood of adverse health events occurring. An overestimation may result in unnecessarily high insurance premiums, while an underestimation may result in lack of coverage to the insurance holder's detriment.

Similarly, when establishing and operating a business, selecting appropriate insurance coverage is a necessity. Different types of business insurance provide different types of coverage. For example, some insurance policies are designed to protect against damages to business's property such as offices, warehouse, vehicles, equipment, and inventory. Others, protect against losses resulting from crimes, such as theft or even employee fraud. Others still, protect the company in the event of a lawsuit (e.g., business liability insurance.)

In some instances, a business entity may be required to purchase certain types of business insurance in order to operate. For example, some states require every business with a certain number employees to have workers compensation, unemployment, and disability insurance. Another example is a requirement to purchase Auto Liability insurance if a business entity owns and/or operates a vehicle.

Because of this multitude of differing types of business insurance policies and requirements, the selection task may be overwhelming, as it requires the business to adequately assess their business needs and risk. For example, recommended coverage levels vary greatly based on each specific business operation in conjunction with the underlying state mandated coverage requirements. Often, conventional insurance companies look to the customer to provide them their needs when selecting an insurance product or policy. However, because most businesses cannot adequately assess their insurance needs, the insurance products and the coverage selected by the customer results in the business being either under- or over-insured. That is, if a company is underinsured, it risks exposing itself to a potential financial loss. Similarly, if the company purchases coverage for events that are either not relevant to their business or have a low incidence of occurrence, the business incurs unnecessary expenses. Accordingly, businesses cannot readily and accurately determine what products and/or coverage levels would be appropriate for their specific business circumstances.

### SUMMARY

The present disclosure provides systems and methods for dynamically adjusting user-specific underwriting information when determining a product and coverage recommendations for mitigating a likelihood of occurrence of adverse incidents.

In one general aspect of the disclosure, a computer-implemented method may include generating a set of master question answers based on underwriting information associated with a plurality of carriers. The set of master question answers may include a first set of question answers and a second set of question answers.

The method may further require determining a plurality of product and coverage recommendations based on user provided responses to the first set of question answers. In some embodiments, the user provided responses to the first set of question answers may include business information associated with a business.

In some embodiments, the method may also include determining a business type of the business entity based on the business information of the business entity, obtaining historical incident information for a plurality of business entities associated with the determined business type, wherein the historical incident information comprises a plurality of historical incidents that have adversely affected the plurality of business entities, and determining a likelihood of occurrence of incidents adversely impacting the business entity based upon the business information of the business entity and the historical incident information. The determined plurality of product and coverage recommendations may be configured to mitigate the likelihood of occurrence of the incidents adversely impacting the business entity.

The method may further require determining a plurality of carriers providing carrier-specific products and coverages corresponding to the plurality of product and coverage recommendations. Next, the method may require generating a user-specific set of question answers by mapping underwriting information associated with the plurality of carriers determined to provide carrier-specific products and coverages to the second set of carrier-specific question answers. In some embodiments, the user provided responses to the user-specific set of question answers may include business information.

Additionally, the method may dynamically adjust the plurality of carriers providing carrier-specific products and coverages based on user provided responses to the user-specific set of question answers. Finally, in parallel with dynamically adjusting the plurality of carriers, the method may dynamically adjust the user-specific set of question answers by eliminating question answers associated with the underwriting information associated with the plurality of carriers that have been eliminated.

In some embodiments, the first set of question answers may include carrier-neutral question answers while the second set question answers may include carrier-specific question answers. In some embodiments, the underwriting information associated with the plurality of carriers comprises underwriting criteria used by the plurality of carriers to determine eligibility. The underwriting criteria may include a plurality of underwriting questions associated with the plurality of carriers. In some aspects of the disclosure, dynamically adjusting the plurality of carriers providing carrier-specific products and coverages may require identifying carriers with the underwriting criteria satisfied by the user provided responses to the user-specific set of question answers. By contrast, the carriers with the underwriting criteria not satisfied by the user provided responses to the user-specific set of question answers are eliminated.

Other embodiments of this aspect may require that user-specific question answer of the user-specific set of question answers may be associated with at least two underwriting questions of the underwriting information associated with at least two carriers. Accordingly, the underwriting information associated with the at least two carriers may be mapped to the same question answer of the second set of carrier-specific question answers.

Implementations may include one or more of the following features. In one embodiment, applying one or more deep learning systems to the underwriting information associated with the plurality of carriers to extract feature representations from the at least one underwriting question, wherein the feature representations comprise one or more feature, and using one or more machine learning models to predict at least one of the carrier-specific question answers for the at least one underwriting question based at least on the feature representations and generate a prediction confidence of the carrier-specific question answers, wherein the one or more machine learning models comprise at least one of a natural language processing (NLP) model. Implementations of the described techniques may include hardware, a method or process, or a computer tangible medium.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 an example system configured to generate product coverage recommendations in a multi-carrier environment, according to an implementation of the disclosure.

FIG. 2 illustrates example modules of the exemplary illustrative multi-carrier product coverage recommendations system, according to an implementation of the disclosure.

FIG. 3 illustrates an example computer based architecture of the exemplary illustrative multi-carrier product coverage recommendations system, according to an implementation of the disclosure.

FIG. 4 illustrates an example process for generating a user-specific set of questions of the exemplary illustrative multi-carrier product coverage recommendations system, according to an implementation of the disclosure.

FIG. 5 illustrates example modules of the exemplary illustrative multi-carrier product coverage recommendations system, according to an implementation of the disclosure.

FIG. 6 illustrates an example computing system that may be used in implementing various features of embodiments of the disclosed technology.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

Described herein are systems and methods for generating insurance product and coverage recommendations using machine learning techniques in a multi-carrier environment. The following embodiments provide technical solutions or technical improvements that overcome technical problems, drawbacks or deficiencies in the technical fields involving multi-carrier integration, underwriting question consolidation and standardization, and real-time, generation of dynamic underwriting questions in a robust, accurate and efficient manner to improve the performance and usability of insurance product and coverage recommendation generation programs and applications, among others.

As alluded to above, over-insurance could strain a business, insufficient coverage presents even greater risks. Acquiring insurance that precisely aligns with a business's requirements, rather than what it assumes it needs, serves to mitigate potential risks and financial strains. Conventional insurance product and coverage recommendations are typically generated based on a limited information, often comprising solely what the business deems necessary. These recommendations are commonly formulated by licensed insurance agents, drawing from their past industry experiences, suggestions from insurance carriers, and generic insurance industry standards. Nevertheless, such conventional approaches frequently fall short in addressing the fundamental challenge of striking a balance between mitigating potential risks and managing insurance costs effectively.

This problem is further complicated by the fact that not all insurance products and respective coverage offered by different carriers are created equal. For example, the same “general liability” product may be offered by two different carriers at the same or similar premium but can be distinguished based on factors such as reliability of coverage, history of coverage expertise, level of responsiveness, claim processing time, and other such similar elements. Furthermore, in some cases these factors may be business classification dependent. Thus, while a construction business may benefit from a general liability policy from carrier “A”, a beauty salon would be better suited to get a general liability policy from carrier “B” because, e.g., carrier “A” has a higher coverage expertise with construction industry while carrier “B” has a higher coverage expertise with beauty industry.

In order to provide a meaningful assessment of products and coverage across multiple carriers, the information collected from the business must be optimized to ensure its usability across all the carriers being evaluated. Carriers usually employ a thorough questioning process to collect business information used to evaluate business applicants and assess their risk profiles accurately. These questions, for example, delve into various aspects of the applicant's business, operations, and risk exposure. Often, carriers seek the same information despite asking for it in different ways. As the questioning progresses, carriers may introduce “knock-out” questions. These questions are designed to pinpoint specific risk factors or red flags that could render all previous answers irrelevant. In other words, a single unfavorable response to a knock-out question may automatically disqualify the applicant from obtaining coverage thereby making all information collected thus far worthless and moot. This type of rigid questioning strains system energy and processing resources consumption and leads to increased data storage demands.

Embodiments of the application identify technically-innovative systems and methods from multiple perspectives. For example, a multi-carrier underwriting module of the multi-carrier product and coverage recommendation system may identify information being sought by different carriers, including “knock-out” questions, and use machine learning techniques and database intercommunication to generate standardized questions intended to elicit essential underwriting information across a plurality of carriers, thereby reducing the number of questions the user has to answer. Furthermore, the present embodiments may dynamically adjust the underwriting questions based on the answers received to avoid questions for repeat or moot information. Furthermore, the present embodiments for generating product and coverage recommendations can implement algorithms and data analytics to computationally asses business information and generate carrier-specific product and coverage recommendations with unprecedented granularity, speed, and accuracy, as an improvement to traditional systems that attempt to generate product recommendations without analyzing coverage needs or evaluating products and coverage across multiple carriers.

As explained in more detail, below, technical solutions or technical improvements herein include aspects of data integration and standardization of underwriting requirements from multiple carriers and data sources (e.g., machine learning algorithms can be used to correlate underwriting questions with related data, standardize terminology, and ensure consistency across different datasets). The multi-carrier underwriting requirements (i.e., underwriting questions) are ingested, parsed, and analyzed, thereby resulting in a master set of question answers. The resulting set of master question answers may further be analyzed to identify a set of carrier-neutral question answers and a set of carrier-specific question answers. The carrier-neutral question answers are used to elicit essential, non-carrier specific underwriting information used to automatically determine non-carrier specific products and coverages. The products and coverages are used to determine a set of carriers which will further be refined based on user responses to user-specific question answers. The user-specific question answers are generated a by mapping underwriting information associated with the carriers determined to provide carrier-specific products and the set of carrier-specific question answers. The user-specific question answers are dynamically adjusted in response to user provided answers, causing for example elimination of certain carriers. Furthermore, the order of the user-specific question answers is dynamically adjusted based on identifying certain “knock-out” questions, which can collapse a series of questions into a single question point, aimed at eliciting carrier-specific underwriting information efficiently. Once all the response are received, the system generates a set of carrier-specific product and coverage recommendations in a robust, accurate, and efficient manner to improve the performance and usability of product and coverage recommendations programs and applications, among others. Based on such technical features, further technical benefits become available to users and operators of these systems and methods. Moreover, various practical applications of the disclosed technology are also described, which provide further practical benefits to users and operators that are also new and useful improvements in the art.

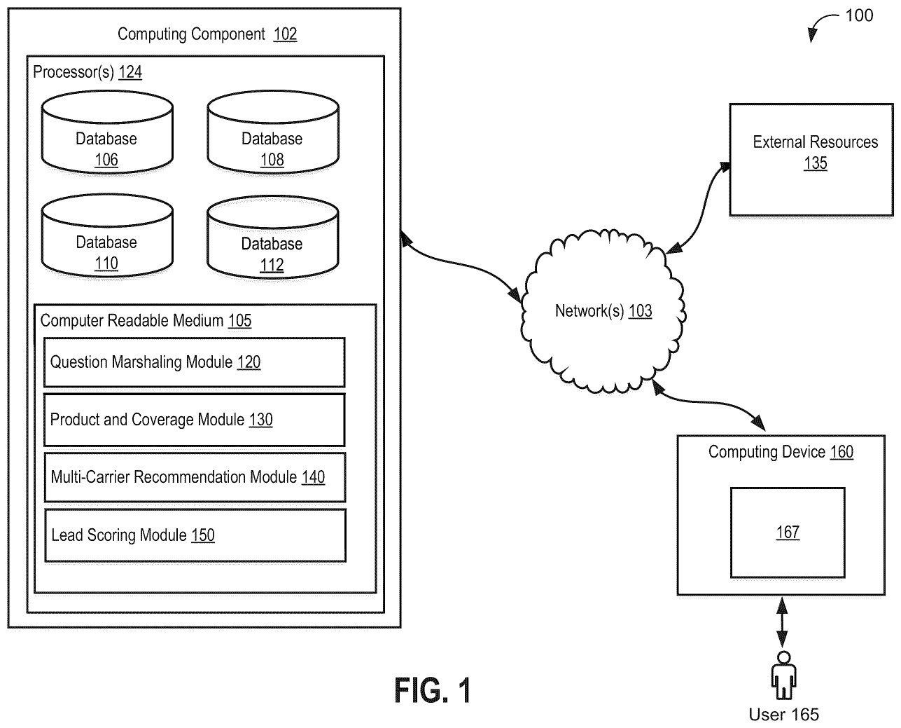

FIG. 1 illustrates diagram of an exemplary illustrative product and coverage recommendation system 100 in a multi-carrier environment according to an illustrative embodiment of the present disclosure.

Product and coverage recommendations in a multi-carrier environment may be generated by the multi-carrier product and coverage recommendation system 100 by: (i) identifying multi-carrier underwriting information (i.e., underwriting requirements) used to by carrier to elicited from users business information through a series of underwriting questions, (ii) generate a master set of question answers by consolidating and standardizing the multi-carrier underwriting information using machine learning to map underwriting information to the master set of question answers by correlating related data affecting categorization and standardization of each question by coordinating various databases and data sources, (iii) identifying and removing duplicate questions from the master set of question answers and generating a carrier-neutral set of questions aimed at eliciting essential underwriting information and a set of carrier-specific question answers to be further developed into a user-specific set, (iv) identifying carrier-specific “knock-out” questions used to collapse a series of questions into a single question point, (v) generating product and coverage recommendation by applying a plurality of expert rules and machine learning techniques which takes into account specific business needs, risk profile, and historical data related to business performance for the type, and other similar data to business information extracted from the answers obtained to the carrier-neutral set of questions, (vi) generating a plurality of carriers that offer the products and coverages recommended, (vii) generating a user-specific set of questions by mapping underwriting information associated with the carriers determined to provide products and coverage to the set of carrier-specific question answers, (vii) dynamically adjusting the user-specific set of questions in real-time predicated on the user provided answers, thereby improving the product and coverage recommendations, (viii) generating carrier-specific product and coverage recommendations (i.e., recommendations that identify the carrier(s) that carry the recommended product and coverage) by applying a plurality of expert and group rules and using machine learning techniques to collate historical data related to business types or classes, underwriting criteria, prevailing market conditions, and other such similar data, (ix) continue to dynamically adjust the user-specific set of questions in real-time aimed at eliminating ineligible carriers (i.e., those carries whose underwriting requirements the user does not meet) and removing duplicate questions, thereby reducing data processing resources, improving speed, and accuracy, as an improvement to traditional systems, (x) ranking individual carrier-specific product and coverage recommendations in accordance to a dynamically determined criteria (e.g., cost, value, risk factors, lead score), (xi) generating an explanation which provides a rationale for each product-coverage recommendation offered by a particular carrier, and (xii) generating an opportunity or “lead score” which determines a likelihood the user will actually follow the carrier-specific product and coverage recommendations generated by the system aimed at providing insurance agents with additional insights into potential customers and/or as a ranking parameter.

In some embodiments, system 100 may include a computing component 102, external resources 135, a one or more client computing devices 160, and a network 103. A user 165 may be associated with client computing device 160 as described in detail below.

In some embodiments, computing component 102 may include a processor 124, a memory, and network communication capabilities. In some embodiments, computing component 102 may be a hardware server. In some implementation, computing component 102 may be provided in a virtualized environment, e.g., computing component 102 may be a virtual machine that is executed on a hardware server that may include one or more other virtual machines. Computing component 102 may be communicatively coupled to network 103. In some embodiments, computing component 102 may transmit and receive information to and from one or more of client computing devices 160, external resources 135, and/or other servers via network 103. In some embodiments, as alluded to above, computing component 102 may include a distributed and a corresponding client application 167 running on one or more client computing devices 160.

In the example implementation of FIG. 1, computing component 102 includes a hardware processor 124 configured to execute one or more instructions residing in a machine-readable storage medium 105 comprising one or more computer program components.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 120-150, to control processes or operations for generating product and coverage recommendations. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 120-150.

In some embodiments, users of multi-carrier product and coverage recommendation system 100 (e.g., business owners and agents) may access the system 100 via client computing device(s) 160. In some embodiments, the various below-described components of FIG. 1 may be used to initiate coverage recommendation application 167 within client computing device 160. In some embodiments, coverage recommendation application 167 may be configured to receive business information entered by user 165 and display multi-carrier product and coverage recommendations determined by computing component 102.

For example, coverage recommendation application 167 may be configured to receive user (e.g., a business owner) input including business name, business type, business activities, and/or other similar information. Additionally, users may input answers to system generated and dynamically updated multi-carrier underwriting questions aimed to satisfy underwriting requirements for a plurality of carriers.

In some embodiments, business owners may be required to provide information related to their business and operations via one or more follow-up questions based on provided information, as described in further detail below.

In some embodiments, external resources 135 may comprise one or more of carrier platforms provided by one or more external carriers or carrier systems. In some embodiments, external resources 135 may comprise one or more underwriting platforms used by one or more carrier agencies or systems. In some embodiments, carrier platforms may include one or more servers, processors, and/or databases that can store business classification information, carrier product information, historic claim information, underwriting information and criterial and other such information provided by one or more external systems resources 135. For example, underwriting information may be used by computing component 102 when performing data integration and standardization of underwriting information from multiple carriers and data sources, identifying knock-out questions that can collapse a series of questions into a single question point, as well as generating a set of master question answers (e.g., which may include a set of carrier-neutral question answers and a set of carrier-specific question answers) and a user-specific set of questions, aimed at eliciting underwriting information efficiently, and determining carrier and product and coverage recommendations, as further described in detail below.

In some embodiments, computing component 102 may communicate and interface with a framework implemented by the external resources 135 using an application program interface (API) that provides a set of predefined protocols and other tools to enable the communication. For example, the API can be used to communicate particular data from an insurance carrier used to connect to and synchronize with computing component 102.

In some embodiments, client computing device 160 may include a variety of electronic computing devices, such as, for example, a smartphone, tablet, laptop, computer, wearable device, television, virtual reality device, augmented reality device, displays, connected home device, Internet of Things (IoT) device, an enhanced general packet radio service (EGPRS) mobile phone, a media player, a navigation device, a game console, a television, a remote control, or a combination of any two or more of these data processing devices, and/or other devices. In some embodiments, client computing device 160 may present content to a user and receive user input. In some embodiments, client computing device 160 may parse, classify, and otherwise process user input. For example, client computing device 160 may store user input associated with an agent claiming or selecting a lead, as will be described in detail below.

In some embodiments, the product and coverage recommendation system 100 receives data from multiple data sources and is related to underwriting criteria, business rules, business owner information, and historical claim information to facilitate comprehensive and accurate prediction of question parameters characteristics for automatically initiating categorization. In some embodiments, the data may include, e.g., underwriting criteria associated with a plurality of carriers, carrier product and coverage data, business rules data, business owner information claim data, and historical claim data, among other data. Accordingly, in some embodiments, the product and coverage recommendation system 100 receives the multi-carrier underwriting criteria and carrier product and coverage data, business rules, business owner information, and historical claim data, from a carrier database 106, a rules database 108, a business information database 110, and historical claim database 112, respectively.

In some embodiments, the carrier database 106 may include underwriting criteria information used by carriers. In some embodiments, the criteria may include, e.g., questions that the carrier may ask the user when determining eligibility including knock-out questions among other question related data. For example, the information may include requests for the type of and industry a business operates in, size of business and its annual revenue, location of business, value of business's property, equipment, and other assets, building construction, fire protection systems, and the age of equipment, risk management strategies, including safety protocols, employee training programs, and disaster preparedness measures, financial statements, credit ratings, and other indicators of stability, as well as employee practices (including hiring practices, employee training, and workplace safety protocols). In some embodiments, the carrier database 106 may receive underwriting criteria (i.e., carrier questions) from carrier platforms and/or programs. Underwriting information ingested from a plurality of carriers may be stored in the carrier database 106 for further consolidation and standardization resulting in generating a set of master question answers (e.g., which may include a set of carrier-neutral question answers and a set of carrier-specific question answers) by question marshaling module 120 aimed at eliciting underwriting information for use by the product and coverage recommendation system 100.

In some embodiments, the rules database 108 may include a plurality of rules including industry expert rules including e.g., rules related to regulatory federal, state, and local regulations that govern commercial insurance coverage. For example, expert rules may relate to federal laws, such as the Employee Retirement Income Security Act (ERISA) which regulate employee benefits, including health insurance, retirement plans, and other welfare benefits offered by businesses, federal environmental laws, such as the Comprehensive Environmental Response, Compensation, and Liability Act (CERCLA), which may impose liability for environmental contamination, potentially requiring businesses to obtain pollution liability insurance, state laws governing workers' compensation insurance, including requirements for coverage, benefit levels, and reporting obligations, state unemployment insurance programs, including employer contributions and eligibility requirements. In some embodiments, expert rules may be ingested from federal, state, and local registers by may be stored in the rules database 108 for use by the product and coverage recommendation system 100.

In some embodiments, the rules database 108 may include rules associated with particular industries (i.e., business classes) and/or individual carriers including e.g., “risk appetite” rules that may relate to a particular carrier's propensity or willingness to insure a particular class of business. In some embodiments, the rules database 108 may include geographic rules associated with particular industries (i.e., business classes) and/or individual carrier including, e.g., particular restrictions carriers may have on insuring a business within a certain geographic area.

In some embodiments, the business information database 110 may include information associated with each user in communication with the product and coverage recommendation system 100. For example, information may be received as user input via client computing device 160. In some embodiments, the information may include responses provided to questions generated by the product and coverage recommendation system 100. In some embodiments, the business information may be extracted or otherwise received from responses provided by the user. In some embodiments, business information may include information characterizing activities of the business. For example, business information may include business type or industry type and sub-type, services provided, customers being serviced, and so on. Business information provided by the users may be stored in the business information database 110 for use by the product and coverage recommendation system 100.

The historical claim database 112 may include a corpus of historical claim information associated with past claim processed by a plurality of carriers associated with the product and coverage recommendation system 100. In some embodiments, the claim data may include, e.g., business information, including business entity type, class of business, policy information, including product information and coverage information, loss information, including loss type, loss date, location of loss (e.g., state), length of claim (from report to close), carrier including underwriting information, carrier score, estimated reserve at time of reporting, final payout by line of coverage, paid or denied status, among other information. Historical claim information may be stored in the business information database 112 for use by the product and coverage recommendation system 100.

As used herein, a “database” refers to any suitable type of database or storage system for storing data. A database may include centralized storage devices, a distributed storage system, a blockchain network, and others, including a database managed by a database management system (DBMS). In some embodiments, an exemplary DBMS-managed database may be specifically programmed as an engine that controls organization, storage, management, or retrieval of data in the respective database. In some embodiments, the exemplary DBMS-managed database may be specifically programmed to provide the ability to query, backup and replicate, enforce rules, provide security, compute, perform change and access logging, or automate optimization. In some embodiments, the exemplary DBMS-managed database may be chosen from Oracle database, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, or objects. In some embodiments, the exemplary DBMS-managed database may be specifically programmed to include metadata about the data that is stored.

In some embodiments, the product and coverage recommendation system 100 may include one or more modules for generating insurance product and coverage recommendations using machine learning techniques in a multi-carrier environment. For example, the system may include: (1) a question marshalling module 120, for performing underwriting question consolidation and standardization based on multiple sources of underwriting criteria for generating a set of master question answers (e.g., which may include a set of carrier-neutral question answers and a set of carrier-specific question answers) and a dynamically updatable user-specific set of questions aimed at eliciting underwriting information that could satisfy underwriting requirements of a plurality of carriers, (2) a product and coverage module 130, for determining carrier-agnostic or generic product and coverage recommendations based on the answers provided by the users in response to the dynamically generated questions determined by the question marshalling module 120, (3) a multi-carrier recommendation module 140, for generating carrier-specific product and coverage recommendations based on the generic product and coverage recommendations determined by the product and coverage module 130 and based on the carriers whose underwriting criteria has been satisfied by the answers received in response to the dynamically adjusted user-specific questions generated by the question marshalling module 120, which may be dynamically adjusted in parallel, and (4) a lead scoring module 150, for generating a likelihood of acquiring the recommended product and coverage from a carrier for each recommendation generated by the multi-carrier recommendation module 140. In some embodiments, the modules may operate simultaneously and cause the output to be dynamically adjusted.

The question marshalling module 120 may generate a set of master question answers configured to elicit answers required by any one carrier. To do so, module 120 may ingest underwiring information from a plurality of carriers, categorize, and map each carrier question to one or more question answers. Question answers may represent a category or a type of question. For example, module 120 may identify that a carrier question “How many employees do you have?” corresponds to the “Number of Employees” question answer, while questions “How much is the primary building worth?” and “How much is the building worth?” correspond to the “Building Value” question answer. Furthermore, module 120 may identify duplicate answers, i.e., questions that correspond to the same answers. For example, rather than asking both “How much is the primary building worth?” and then “How much is the building worth?”, module 120 may eliminate one of the carrier questions.

In some embodiments, when generating the question answers, the question marshalling module 120 may categorize underwriting questions based on categorization parameters determined first. For example, the data from the carrier database 106 associated with underwriting information and/or regulatory data from the rules database 108 may be used to determine categorization parameters (e.g., underwriting question category and sub-category, underwriting question purpose, underwriting question type, and similar parameters) based on underwriting criteria, underwriting questions, regulatory information, and historical claim data other, based on data from one or more of the carrier database 106, the rules database 108, the business information database 110, and historical claim database 112. In some embodiments, the question marshalling module 120 may include, e.g., machine learning models, such as, e.g., one or more exemplary AI/machine learning techniques chosen from, but not limited to, decision trees, boosting, support-vector machines, neural networks, nearest neighbor algorithms, Naive Bayes, bagging, random forests, and the like.

The product and coverage module 130 may determine carrier-agnostic product and coverage recommendations by applying expert rules, business rules and machine learning techniques which takes into account specific business needs, business risk profile, and historical data related to business performance for the business type or class.

The multi-carrier recommendation module 140 may identify specific carriers that offer the recommended product and coverage determined by module 130 and whose underwriting criteria has been satisfied by the business information received from the user in response to questions generated by the question marshalling module 120. The module 140 may identify specific carriers by applying appetite mapping rules, filters (e.g., class filter, state filter, coverage and limit filter) and machine learning techniques which takes into account historical claim data, risk data, and other similar data.

The lead scoring module 150 may determine a “lead sore” or a score representing a likelihood the business user will acquire the recommended product and coverage from a carrier for each recommendation generated by the multi-carrier recommendation module 140.

In some embodiments, modules 120-150 may be configured to operate simultaneously or in parallel and cause the output of each module to be dynamically adjusted. In some embodiments, the question marshalling module 120 may be configured to operate at the same time as the product and coverage module 130 is making determinations for carrier-agnostic product and coverage recommendations. For example, upon receiving the information that user's business serves alcohol, the product and coverage module 130 may identify 3 products that the business owner my need. However, products 1 and 2 provide liability coverage for selling all types of liquor, while product 3 is intended for liability coverage for selling beer and wine only (i.e., not liquor). That is, if the business does not sell liquor then questions related to products 1 and 2 will be eliminated. Upon receiving information that the business only sells beer and wine, module 130 may determine that products 1 and 2 should no longer be recommended. This triggers module 120 to dynamically update user-specific questions by removing those questions associated with products 1 and 2.

Similarly, as the multi-carrier recommendation module 140 identifies specific carriers that offer the recommended product and coverage (as determined by module 130), the question marshalling module 120 may be configured to continuously update the user-specific questions. For example, the multi-carrier recommendation module 140 may identify 5 carriers that offer the recommended products. This triggers module 120 to dynamically update user-specific questions that are specific to these 5 carriers. For example, carrier 4 may only insure customers that have been in business for 10 years. That is, if the business has been operating for less than 10 years, then answering any other specific carrier 4 questions may be moot. In this example, the time of operation may be considered a “knock-out” question. By determining this “knock-out” question may trigger module 120 to prioritize the order of asking this question before all others.

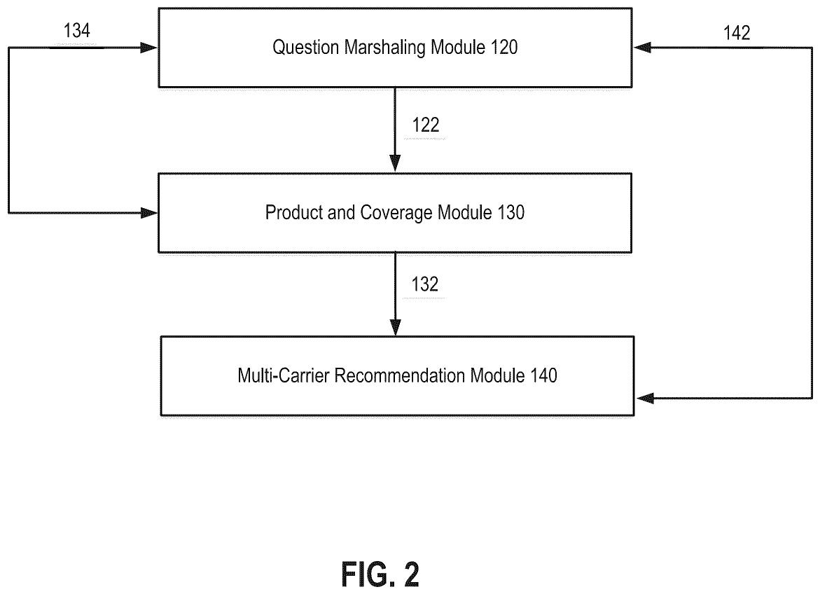

FIG. 2 illustrates the operation of question marshalling module 120, product and coverage module 130, and the multi-carrier recommendation module 140. For example, in step 122 of question marshalling module 120 may generate a set of user-specific questions the responses to which are utilized by product and coverage module 130. As module 130 identifies potential product and coverage recommendations in step 134, module 120 dynamically updates user-specific questions by continuously performing step 122, as described above. Next, product and coverage module 130 transmits the product and carrier determinations in step 132 to multi-carrier recommendation module 140. Similarly, as multi-carrier recommendation module 140 identifies potential carriers in step 142, module 120 dynamically updates user-specific questions by continuously performing step 122, as described above.

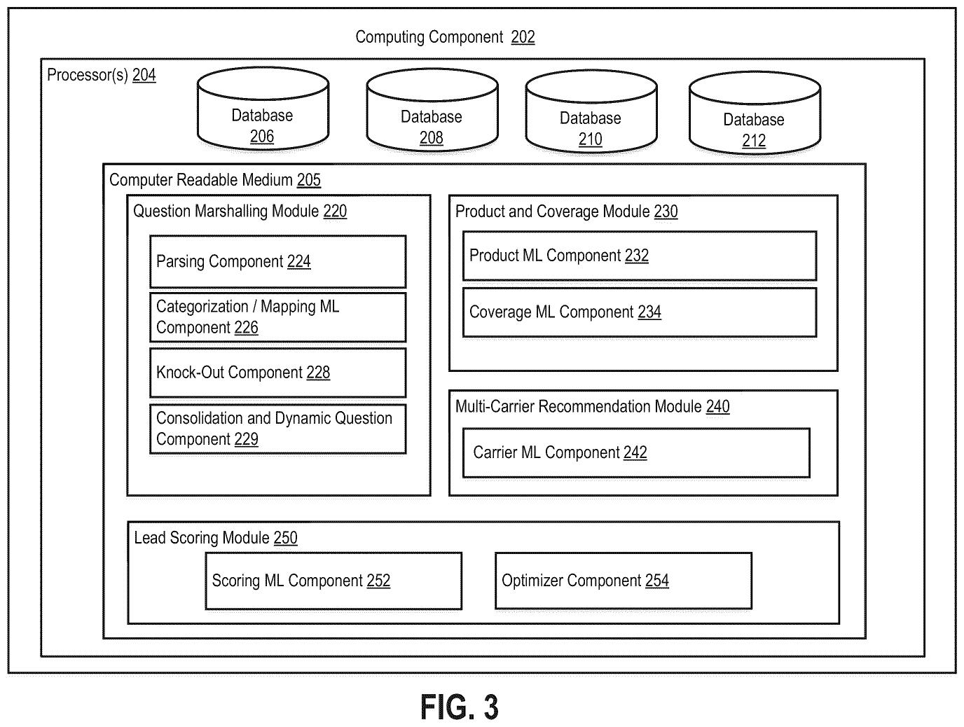

FIG. 3 depicts a diagram of an exemplary illustrative a multi-carrier product and coverage recommendations system according to an illustrative embodiment of the present invention. For example, FIG. 3 illustrates a computing component 202 which includes a hardware processor 204 configured to execute one or more instructions residing in a machine-readable storage medium 205 comprising one or more computer program components. Processor 204 may fetch, decode, and execute instructions 220 (i.e., question marshalling module 220), 230 (i.e., product and coverage module 230), 240 (i.e., multi-carrier recommendation module 240), and 250 (i.e., lead scoring module).

The question marshalling module 220 may be configured to control processes or operations for automatically categorizing multi-carrier underwriting questions before generating a set of master question answers, which may also include a set of carrier-neutral question answers and a set of carrier-specific question answers, and a dynamically updatable user-specific set of questions aimed at eliciting underwriting information that could satisfy underwriting requirements of a plurality of carriers. The question marshalling module 220 may be in communication with databases, such as, a carrier database 206, a rules database 208, a business information database 210, and a historical claim database 212, among other suitable databases. In some embodiments, each of the databases may include data in a suitable format, such as, e.g., tables, text, tuples, arrays, etc. Each data item in the databases may also include metadata associated with information such as, e.g., origin of the data, format, time and date, source identifier (ID), among other information.

In some embodiments, the question marshalling module 220 may leverage the data in the databases, including associated metadata, to determine and predict question category or sub-category for each question, such as questions in the same category or sub-category from different carriers may be directed to the elicit the same information. By categorizing the questions, the question marshalling module 220 may optimize underwriting information query by reducing the number of questions. For example, questions from the same category may be grouped together to eliminate repeated questions during question set generation.

In some embodiments, the question marshalling module 220 may predict the question category or sub-category using the data in the categorization databases. The question marshalling module 220 may receive the data and employ a parsing component 224, a question categorization machine learning component 226 to deduce a correlation between the data and a most probable question category relative to other questions or relative to the user should categorize the question, or both.

In some embodiments, each of the parsing component 224 and categorization machine learning component 226 may include, e.g., software, hardware or a combination thereof. For example, in some embodiments, the parsing component 224 may include a processor and a memory, the memory having instructions stored thereon that cause the processor to parse data. In some embodiments, the categorization machine learning component 226 may include a processor and a memory, the memory having instructions stored thereon that cause the processor to predict question category from the parsed data.

In some embodiments, the parsing component 224 may transform the data, such as, e.g., question subject, related questions, etc., into feature vectors or feature maps such that the question categorization machine learning component 226 may generate a question category determination. Next, the categorization machine learning component 226 may make category predictions based on features of the data.

Thus, in some embodiments, the parsing component 224 may receive the data, parse the data, and extract features according to a feature extraction algorithm. Data parsing and feature extraction may utilize methods depending on a type of data being received. For example, the parsing component 224 may include language parsing when the data includes text and character strings. Thus, in some embodiments, the parsing component 224 may include text recognition models including, e.g., a classifier for natural language recognition.

However, in some embodiments, the data may be a table. In such a case, the parsing component 224 may simply extract features into, e.g., a feature vector directly from the data. However, in some embodiments, the data may include a combination of character strings, as well as structured data, such as tables, tuples, lists, arrays, among other. Thus, in some embodiments, the parsing component 224 may include model or algorithm for parsing the character strings and then extracting feature vectors from the structured data and the parsed character strings. For example, the parsing component 224 may use natural language processing (NLP) to perform analysis on the multi-carrier underwriting questions. The NLP may be or include any kind of NLP engine, such as a general-purpose NLP engine (e.g., the Natural Language Toolkit (NLTK), spaCy, Stanford NLP, or OpenNLP), a domain-specific (e.g., prescription-specific) NLP engine, Lab NLP, or the Linguamatics), or a Large Language Model (LLM) of any kind(s).

In some embodiments, the feature extraction algorithm of the parsing component 224 may include, e.g., independent component analysis, an isomap, kernel principle component analysis (PCA), latent semantic analysis, partial least squares, principal component analysis, multifactor dimensionality reduction, nonlinear dimensionality reduction, multilinear PCA, multilinear subspace learning, semidefinite embedding, autoencoding, among others and combinations thereof. As a result, the parsing component 224 may capture the semantic meaning and context of the question (i.e., information which may influence the question category) by generating feature vectors having, e.g., text structure or text description, or frequency of certain words, among other possible features. For example, the textual description and the title or name of the question may be converted into a feature vector using techniques such as Bag-of-Words (BoW), Term Frequency-Inverse Document Frequency (TF-IDF), or word embeddings (e.g., Word2Vec, GloVe).

In some embodiments, the question categorization machine learning component 226 is configured to make at least one prediction in response to the feature vectors: a question category used in generating question sets including knock-out question identification.

For example, the question categorization machine learning component 226 may include, e.g., a convolutional neural network (CNN) having multiple convolutional layers to receive a feature map composed of each of the feature vectors, convolutionally weight each element of the feature map using the convolutional layers, and generate an output representing the question category parameter.

The categorization machine learning component 226 may determine categories (e.g., business type, business size, annual revenue, location of business, value of business's property, equipment, and other assets, building construction, fire protection systems, and the age of equipment, risk management strategies, including safety protocols, employee training programs, and disaster preparedness measures, financial statements, credit ratings, and other indicators of stability, as well as employee practices) based on question content, question contextual data, question elicited information, among other data, based on data from one or more of the carrier database 206, the rules database 208, the business information database 210, and the and historical claim database 212.

In some embodiments, the question marshalling module 220 may include, e.g., machine learning models, such as, e.g., one or more exemplary AI/machine learning techniques chosen from, but not limited to, decision trees, boosting, support-vector machines, neural networks, nearest neighbor algorithms, Naive Bayes, bagging, random forests, and the like.

In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments, the knock-out question component 228 may be configured to identify critical or knock-out questions as the output from the multi-carrier recommendation module 240 is received. For example, the knock-out question component 228 may use machine learning techniques to identify one or more carrier-specific questions that may be may automatically disqualify the applicant from obtaining coverage. The knockout question component 228 may determine the sequence of the questions being asked ensuring the all knock-out questions are being asked earlier thereby eliminating any further questioning from that carrier.

In some embodiments, the consolidation and dynamic question component 229 may be configured to dynamically update the questions by taking the input generated by the question marshalling module 220, e.g., the parsing component 224, the categorization machine learning component 226, and/or knock-out question component 228. In some embodiments, component 229 may use one or more machine learning models, such as, e.g., one or more exemplary AI/machine learning techniques chosen from, but not limited to, decision trees, boosting, support-vector machines, neural networks, nearest neighbor algorithms, Naive Bayes, bagging, random forests, and the like. For example, component 229 may update the questions by continuously analyzing the input received from the user thereby continuously identifying questions that may need to be added or removed.

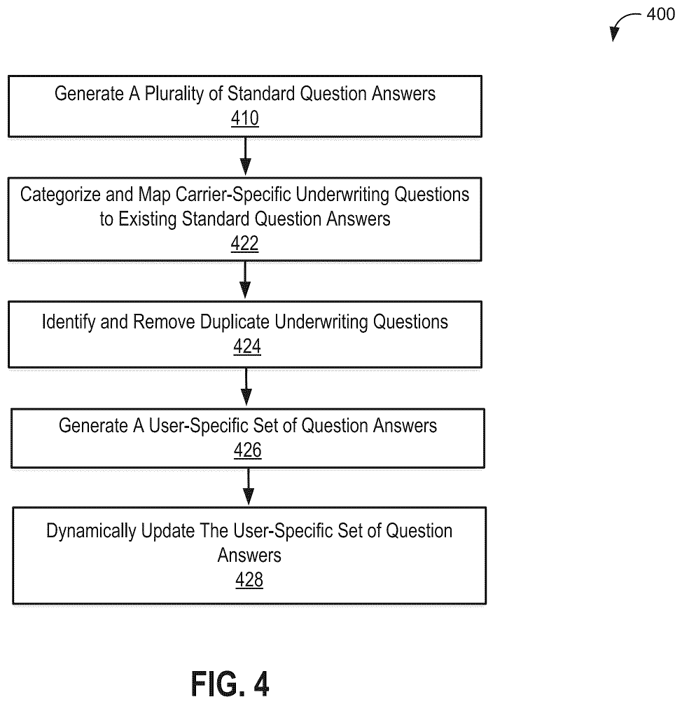

FIG. 4 illustrates an example process for generating user-specific underwriting questions in a multi-carrier environment, in accordance with one embodiment. In some embodiments, method 400 can be implemented, for example, on a server system, e.g., computing component 102, 202, as illustrated in FIGS. 1, 3, respectively. In step 410, standard question answers are generated. For example, the standard question answers may be generated from reviewing underwiring information from all available carriers, as explained earlier. Exemplary question answers may include “Number of Employees” and “Building Value”. Next, in step 422, the underwriting information associated with carriers identified by the multi-carrier recommendation module, module 240, as illustrated in FIG. 3, is categorized and mapped to the standard question answers generated in step 410. For example, a carrier question “How many employees do you have?” may be mapped to the “Number of Employees” answer while carrier questions “How much is the primary building worth?” and “How much is the building worth?” may be mapped to the “Building Value” answer. In step 424, the underwriting questions mapped to the same question answer may be identified causing the removal of duplicates. For example, only one of the questions mapped to the “Building Value” questions answer may be used, since asking “How much is the primary building worth?” and “How much is the building worth?” would cause the user to enter duplicate information. In step 426, a user-specific set of questions is question answers is generate. This user-specific set of question answers includes non-duplicate questions answer mapped to underwriting information of all carriers identified by the multi-carrier recommendation module in step 422. Finally, in step 428, this user-specific set of question answers mapped with carrier-specific underwriting information may be continuously updated or adjusted based on the information received from user. For example, upon providing the answer that the Building Value is under $1 M, some carriers may become ineligible, thus causing the process to remove any questions associated with that carrier.

Referring back to FIG. 3, business information provided by the user in response to underwriting questions may be used by product and coverage module 230 of computing component 202 to generate carrier-agnostic product and coverage recommendations based on specific business information and circumstances. The product and coverage module 230 may receive the data in the form of answers provided by the user in response to questions generated by the question marshalling module 220 and employ a product machine learning component 232 and a coverage machine learning component 234 to determine one or more product and coverage recommendations, respectively, likely to lower potential risk associated with one or more insurable incident, as explained in detail herein.

In some embodiments, product and coverage recommendations are generated based on a likelihood of insurable event occurring for a business. The likelihood of insurable event, as described in detail below may be based, at least in part, on the type of activities the business is engage in. For example, business entities of a particular type and/or those operating in a particular geographical area may be associated with a particular industry ranking or hazard grade with known likelihoods of insurable event occurrence. By virtue of determining a business type (e.g., classifying business activities) results in a more accurate product and coverage recommendation. In some embodiments, business type may be determined by using user specified information related to activity of the business, as described herein.

In some embodiments, product machine learning component 232 may be configured to determine industrial classification and/or liability class and industry, an industry group, a subsector, and a sector using the natural language description of the business provided by the user. For example, product machine learning component 232 may use natural language processing (NLP) to perform analysis on the natural language description of the business provided by the user. The NLP may be or include any kind of NLP engine, such as a general-purpose NLP engine (e.g., the Natural Language Toolkit (NLTK), spaCy, Stanford NLP, or OpenNLP), a domain-specific (e.g., prescription-specific) NLP engine, Lab NLP, or the Linguamatics), or a Large Language Model (LLM) of any kind(s).

In some embodiments, the product machine learning component 232 may transform the data, such user provided description information and other such business related information, into feature vectors or feature maps such that the product machine learning component 232 may generate a data category determination. Next, the product machine learning component 232 may make category predictions based on features of the data. For example, the user may enter a statement “I mow grass” or “I lay shingles.” In some embodiments, product machine learning component 232 may analyze the natural language input and determine that the user performs landscaping services or roofing services, respectively. In other embodiments, product machine learning component 232 may determine that the business performs multiple activities resulting in multiple classifications, as further described in detail below.

In some embodiments, product machine learning component 232 may be configured to determine an industry, an industry group, a subsector, and a sector based on business information provided by the user. For example, upon receiving user input indicating their business activity includes grass mowing, product machine learning component 232 may determine their industry as “Landscaping Services”, industry group as “Services to Buildings and Dwellings”, subsector as “Administrative and Support Services”, and sector as “Administrative and Support and Waste Management and Remediation Services.”

In some embodiments, product machine learning component 232 may determine multiple industries, industry groups, subsectors, and sectors based on business information comprising distinct groups of business activities performed by the user, as alluded to above.

In some embodiments, product machine learning component 232 may be configured to determine a corresponding industry, industry group, subsector, and sector associated with one or more insurers based on the business classification (i.e., industry, an industry group, a subsector, and a sector) determined using the business information provided by the user.

In some embodiments, business information may include information related to business specifications. For example, information related to the types of clients the business services, information related to supplier and vendors, transactions and transaction types performed by the business, business revenue information, including monthly, quarterly, and annual revenue information, business property information, employee information, geographic location(s) in which the business entity operates information, and other such information.

In some embodiments, product machine learning component 232 may determine that the information provided by the user is insufficient and be configured to prompt the user with questions which are configured to elicit additional information related to users' business operations. For example, information may include questions clarifying whether the services are being performed at customer location only, whether additional activities, not typically associated with the business information (e.g., whether a beauty salon serves alcohol to its customers) and so on.

In some embodiments, product machine learning component 232 may be configured to identify additional information that may be collected from the user. In some embodiments, the consolidation and dynamic question component 229 of the question marshalling module 220 may be configured to generate additional questions based on the identified information so that the input received from the user may be applicable in the context of multi-carrier underwriting requirements.

In some embodiments, product machine learning component 232 may be configured to use machine learning, i.e., a machine learning model that utilizes machine learning to determine business classification based on user input. For example, in a training stage product machine learning component 232 (or other component) may be trained using training data (e.g., business activity and business classification training data) or actual business activity and business classification data in a classification determination context, and then at an inference stage can determine classification. For example, the machine learning model can be trained using synthetic data, e.g., data that is automatically generated by a computer, with no use of user information.

In some embodiments, product machine learning component 232, may be configured to use machine learning to determine one or more user preferences, e.g., preferences for coverage, cost, convenience, best value, among other user preferences.

In some embodiments, product machine learning component 232 may be configured to use one or more of a deep learning model, a logistic regression model, a Long Short Term Memory (LSTM) network, supervised or unsupervised model, etc. In some embodiments, product machine learning component 232 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

Next, the product machine learning component 232 may be configured to determine one or more insurable incidents associated with the business and a likelihood of each insurable incident occurrence based on the business information provided by the user and determined industrial classification and/or liability class. An insurable incident may include an incident that takes place during a particular time period and causes a potential loss for the business. The potential loss may include property and equipment damage, a customer injury, a breached vendor agreements, an employee injury, lawsuit, loss of business income, loss of reputation, negligence, and so on. For example, the business information indicating that employees working at a beauty salon have less than two years of experience may be used by the product machine learning component 232 to determine a likelihood of an insurable event occurrence, e.g., injuring a customer with scissors during a haircut for a beauty salon, is relatively high.

Further, the product machine learning component 232 may be configured to determine a likelihood of each insurable incident occurrence. For example, upon determining a insurable event that includes injuring a customer with scissors during a haircut, as alluded to above, product machine learning component 232 may determine a likelihood of 60 percent of an injury to a customer.

In some embodiments, when determining a likelihood of each insurable incident occurrence, product machine learning component 232 may utilize business information including, business type or industry type, types of services provided, use of vehicle, servicing clients at their locations, use of suppliers, business revenue information, number of employees, licensing requirement, number of employees, level of experience and/or education of employees, geographic location(s) in which the business operates, and other such information. In yet other embodiments, product machine learning component 232 may utilize additional relevant data that may be obtained or determined based the business information. For example, product machine learning component 232 may obtain or determine relevant financial data related to other business of the industry type or sub-type including revenue and growth projections; regulatory requirements including new regulations that may come in effect in the near future; information related to assets owned or operated by the business, such as buildings and vehicles, including engineering data, material data and other similar information, motor vehicle record data, and loss history; crime data including modeling and analysis data; wind/hail loss data, including modeling and analysis data; flood map analysis data, earthquake zone analysis data, probable maximum loss analysis data; existing or future contractual obligation analysis data; satellite imagery analysis data, social network analysis data, public protection classification data, including responsiveness of fire department and water availability, loss cost analysis, and so on. In some embodiments, product machine learning component 232 may utilize both publicly and non-publicly available information.

In some embodiments, product machine learning component 232 may be configured to use historic data related to other clients' businesses when making the insurable incident and the likelihood of each insurable incident occurrence determinations. For example, product machine learning component 232 may obtain historic claim data stored in database 212 related to businesses in the same industry.

In some embodiments, product machine learning component 232 may be configured to rank industries within an industry group of the user's business based on an order of relatedness. For example, if no historic information exists for an industry category of the business, product machine learning component 232 may identify comparable industries within the industry group by using a relatedness score. In some embodiments, if no data within any of the industries within the same industry group is found, product machine learning component 232 may be configured to rank industries in other industry groups under the same subgroup, and so on. For example, if no data is found in the Hair Salon industry, product machine learning component 232 may use data in the Barber or Nail Salon industry within the Personal Care Services industry group. Similarly, if no data is found in the Hair Salon industry, product machine learning component 232 may use data found in a Personal Trainer industry within Professional Services subgroup. By virtue of using the relatedness score results in an accurate determination of future insurable incident occurrence despite lack of actual historic data within the same industry.

In some embodiments, product machine learning component 232 may be configured to determine the insurable incident and the likelihood of each insurable incident occurrence using a number of models or methods. For example, Bayesian-type statistical analysis may be used during the likelihood determination.

In some embodiments, product machine learning component 232 may be configured to assign specificity, relevance, confidence, and/or weight to each business attribute used in determining insurable incidents and the likelihood of these incidents occurring. For example, business type or industry type, services provide type, use of vehicle, servicing clients at their locations, use of suppliers, business revenue information, number of employees, licensing requirement, number of employees, level of experience and/or education associated with employees, geographic location(s) in which the business operates, and/or other information may be assigned with specificity, relevance, confidence, and/or weight based on the relevance and relationship between each data point to one another. For example, a higher weight may be assigned to business industry, but a lower weight may be assigned level of employee education. By virtue of assigning different weights to individual business attributes, allows product machine learning component 232 to determine the likelihood more accurately.

In some embodiments, a likelihood of each insurable incident occurrence may be expressed as an incident score. For example, an incident score may be expressed on a sliding scale of percentage values (e.g. 10 percent, 15 percent, . . . n, where a percentage may reflect likelihood of conversion occurrence), numerical values (e.g., 1, 2, . . . n, where a number may be assigned as low and/or high), verbal levels (e.g., very low, low, medium, high, very high, and/or other verbal levels), and/or any other scheme to represent a confidence score. For example, product machine learning component 232 may determine that injuring a customer with scissors has a 60 percent likelihood of occurring, whereas a customer slipping on upswept hair has a 30 percent likelihood of occurring.

In some embodiments, product machine learning component 232, may be configured to utilize machine learning to determine the insurable incident and the likelihood of each insurable incident occurrence based on user input. For example, in a training stage the product machine learning component 232 (or other component) may be trained using training data (e.g., business activity, business classification training data, and historical claim data) or actual business activity and business classification data in an insurable incident determination context, and then at an inference stage can determine insurable incident and the likelihood of each insurable incident occurrence. For example, the machine learning model can be trained using synthetic data, e.g., data that is automatically generated by a computer, with no use of user information.

In some embodiments, product machine learning component 232 may be configured to use one or more of a deep learning model, a logistic regression model, a Long Short Term Memory (LSTM) network, supervised or unsupervised model, etc. In some embodiments, product machine learning component 232 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

### Product Recommendation

In some embodiments, product machine learning component 232 may be configured to determine one or more carrier-agnostic products or product recommendations relevant to the user's needs based on business classification and the likelihood of insurable incident occurrence determination. In some embodiments, product determinations may include one or more products to protect against a particular risk. In some embodiments, products may include products for protecting business interests. For example, products may include Property Insurance, Business Income Coverage, Business Owner's Policy, Comprehensive General Liability, Bodily Injury Liability, Property Damage, Liability, Operations Exposures, Advertisers Personal, Fire Legal Liability, Medical Payments, Commercial Auto, Data Breach, Umbrella Insurance, Fidelity and Surety Bonds and Workers Compensation among others. In other embodiments, products may include products for protecting personal health or life interests of users.

In some embodiments, coverage machine learning component 234 may be configured to determine coverage limits or levels associated with each product determined relevant to user's needs by the product machine learning component 232. For example, coverage limits may include a maximum amount of loss associated with a claim made for individual product. In some embodiments, coverage machine learning component 234 may determine that the business uses tools valued at $4,000 at locations outside of the business premises. Based on this determination, coverage machine learning component 234 may determine that the policy limit must cover up to at least $4,000 of property damage, when property is used outside the business premises.

In some embodiments, coverage machine learning component 234 may be configured to determine product and coverage limits based on one or more rules. For example, coverage machine learning component 234 may use federal, state, and local rules to determine workers compensation coverage requirements. That is, if the user's business operates in Missouri and employs four people, coverage machine learning component 234 may determine that workers compensation insurance is not required for that user by applying state rules.

In some embodiments, one or more rules and conditions may be applied by the coverage machine learning component 234 when determining product and coverage limits. In some embodiments, the same product may be recommended in distinct circumstances. For example, cyber insurance product may be determined to be relevant if business information indicates that the business processes and stores credit card payment information. Additionally, cyber insurance product may be determined to be relevant if business information indicates that the business stores personally identifiable information.

The carrier-agnostic product and coverage recommendations determined by the product and coverage module 230 may be used by the multi-carrier recommendation module 240 to determine specific carriers that that offer the determined product and coverage combinations. Similarly to product machine learning component 232, the multi-carrier recommendation module 240 may receive data entered by the user in response to questions generated by the question marshalling module 220 and employ a carrier machine learning component 242 to determine a correlation between the most likely product and coverage recommendation and eligible carriers whose underwriting criteria has been satisfied by the user-specific set of standardized questions relative to other carriers.

In some embodiments, multi-carrier recommendation module 240 may analyze the carrier-agnostic product and coverage recommendations determined by the product and coverage module 230 in the context of eligible carriers, i.e., those carriers whose underwriting criteria has been satisfied by the user provided answers to the questions generated by the question marshalling module 220 will be considered. For example, multi-carrier recommendation module 240 may use business information provided by the user to identify carriers that offer the products and coverages determined by module 230.

In some embodiments, business information provided by the user in response to underwriting questions may be used by multi-carrier recommendation module 240 to evaluate the type and/or an industry classification of the business and determine a liability class which may be used to quantify the risk assumed by the carriers. For example, the liability class may include a numeric or an alphanumeric code used by carriers for calculating insurance premiums.

Many carriers base their liability class codes on data collected by the Insurance Services Office (ISO). Alternatively, some carriers consider other organization's data, such as that provided by the North American Industry Classification System (NAICS), the Standard Industrial Classifications (SIC) or the National Council on Compensation Insurance (NCCI). Additionally, insurers are free to use their own information that they collect themselves. Notably, insurers do not all use the standardized liability class codes. Thus, carriers' lists of codes vary. Accordingly, by making an accurate business industry classification and corresponding liability class determination across carriers is critical for optimizing product and coverage recommendations in a multi-carrier setting. In contrast, a misclassification of the business may result in improper insurance recommendation and lead to insufficient coverage. For example, if a tattoo artist is incorrectly categorized as a retail artist rather than a provider of personal care services, they may be mistakenly not be recommend professional liability insurance coverage, which protects against mistakes made during tattooing. Moreover, this misclassification could lead to rejected claims, potentially placing responsibility on the insurance broker for the inaccurate classification. This is because, in some instances, products offered by different carriers may be more suitable for different businesses based on a variety of factors including e.g., business types, underwriting criteria, prevailing market conditions, and other such similar data. For example, different carriers may have different coverage limits.

In some embodiments, carrier machine learning component 242 may be configured to identify carriers offering the one or more relevant products and coverages using a number of models or methods. For example, Bayesian-type statistical analysis may be used during the carrier product and coverage determination in a multi-carrier setting. In some embodiments, the carrier machine learning component 242 may include, e.g., a convolutional neural network (CNN) having multiple convolutional layers to receive a feature map composed of each of the feature vectors, convolutionally weight each element of the feature map using the convolutional layers, and generate an output representing the product parameter, coverage parameter, and carrier parameter. For example, the methods employed by the carrier machine learning component 242 may collate historical data related to business types, underwriting criteria, prevailing market conditions, and other such similar data, when identifying carriers. By analyzing the product offered by each carrier in light of business information and/or user preferences, carrier machine learning component 242 may generate the recommendation for product and coverage for each available carrier.

In some embodiments, carrier multi-carrier recommendation module 240 may be configured to determine one or more preferences associated with a user of a business entity. For example, user's preferences may include price consideration, convenience considerations, time considerations, best value considerations, and other similar considerations. This is, especially relevant when determining the coverage portion of the product and coverage recommendation.

For example, carrier machine learning component 242 may utilize the one or more determined personal preferences, as alluded to above, to determine whether a product X from carrier “A” with coverage 1 at a higher premium, should be recommended over product X offered by carrier “B”, which is offered with coverage 2 but at a lower premium, where coverage 1 is more comprehensive than coverage 2. The carrier machine learning component 242 may determine that the user that values premium over coverage may be willing to give up some coverage (while still maintaining the recommended level) and would benefit from selecting product X from carrier “B.”

In some embodiments, carrier machine learning component 242 may be configured to use one or more of a deep learning model, a logistic regression model, a Long Short Term Memory (LSTM) network, supervised or unsupervised model, etc. In some embodiments, carrier machine learning component 242 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments, carrier machine learning component 242 may be configured to determine whether bundling of products offered by the different carriers would result in a more preferred option for the business by utilizing the one or more personal preferences determined by multi-carrier recommendation module 240, as alluded to above. For example, different carriers may offer different products with different coverage limits and different premiums. In this illustrative example, carrier “A” offers Business Owners Policy (BOP) product at an annual premium of $1,000 but does not offer a Professional Liability (PL) product. Alternatively, carrier “B” offers both a BOP product and a PL product, however, the BOP product is offered at an annual premium of $1,500. Circumstances may exist that would make it more cost effective to purchase the BOP product form carrier “A” (at a lower premium) and the PL product from carrier “B.” In other circumstances, it may be more cost effective to purchase both the more expensive BOP along with the PL policy from carrier “B.” For example, carrier “B” may offer a discount if both products are purchased altogether (i.e., bundled). In other cases it may be more convenient to purchase both the more expensive BOP along with the PL product from carrier “B.” For example, it may be easier for the customer to only pay one bill associated with carrier B.

In some embodiments, carrier performance metrics may be used by the carrier machine learning component 242 when to identify carriers for product and coverage recommendations determined by the product and coverage module 230. For example, one or more carrier performance metrics may include carrier's claim handling rate, reputation, financial stability, third-party ratings, and or other similar which may be used by carrier machine learning component 242. In some embodiments, carrier machine learning component 242 may be configured to assign specificity, relevance, confidence, and/or weight to different products and different coverage limits offered by each carrier as well as each carrier performance factor, described above, during carrier determination.

In some embodiments, multi-carrier recommendation module 240 may rank individual carriers offering the same product having a particular coverage in accordance to a dynamically determined criteria including cost, value, risk factors, ease of conducting business, likelihood of retention, quality of the carriers' service center to the shared customer of the carrier, among other criteria factors.

In some embodiments, multi-carrier recommendation module 240 may be configured to generate a carrier-specific recommendation for each product coverage determination made by module 230. In some embodiments, multi-carrier recommendation module 240 may be configured to generate one or more recommendations based on multi-carrier product and coverage determinations. In some embodiments, multi-carrier recommendation module 240 may be configured to determine multiple products associated with one or more carriers. For example, product coverage machine learning component 242 may be configured to assign a preference to a particular product determination by indicating that this product(s) is preferred or recommended.

In some embodiments, multi-carrier recommendation module 240 may be configured to generate an explanation detailing reasons why a particular carrier product and coverage is preferred over another. In yet other embodiments, multi-carrier recommendation module 240 may be configured to generate an explanation which provides a rationale for recommending each product having a particular coverage offered by a particular carrier. For example, an explanation may include a reason or rationale why a particular insurance product is applicable to user's business circumstances. For example, a reason a business owner needs a Business Owners Policy (BOP) is because it covers property damage including, real property and equipment or vehicles. For example, based on the business information, indicating that the user is an accountant working in a rented building, the recommendation may state: “You need a BOP in case someone slips and falls on your property.” Alternatively, if the business information indicates that user is an accountant that works with clients remotely from his home but also visits their client's sites, the recommendation may state: “You need a BOP to cover your loss if your presence at the client's home or office causes damage or injury.” In some instances, in addition to property damage, BOP may also cover reputational damage (e.g., defamation). In that scenario, even if the business information indicates that user is an accountant that works with clients remotely from his home, the recommendation may state: a client is sued for a marketing campaign you suggested.”

Alternatively, multi-carrier recommendation module 240 may be configured to generate an explanation which provides the rationale for not recommending a particular product having a particular coverage offered by a particular carrier. For example, products having a particular coverage offered by a particular carrier that are not determined to be the most suitable to the business. By virtue of generating less applicable products, the user is presented with an overview of all available products and coverage combinations form a variety of carriers rather than only those determinations the system deems applicable. For example, multi-carrier recommendation module 240 may include Hired and Non Owned Auto product and indicate that it is not recommended because the user indicated the business employees do not drive their own vehicles to perform their job. Similarly, multi-carrier recommendation module 240 may include Workers Compensation product and indicate that it is not recommended because the user indicated the business employs only three employees, which does not meet the state requirement for Workers Compensation, and because excluding Worker Compensation product lowers the overall cost which is a consideration for the user.

In some embodiments, multi-carrier recommendation module 240 may rank carrier-specific recommendations for product and coverages in accordance to a dynamically determined criteria including user preferences, cost, value, risk factors, among other criteria factors. In yet other embodiments, module 240 may use a “lead score”, determined by lead scoring module 250, described below, to rank the recommendations.

As alluded to above, lead scoring module 250 may determine a lead score which determines a likelihood the user will actually follow the carrier-specific product and coverage recommendations generated by module 240. The lead scoring module 230 may employ a scoring machine learning component 252 and an optimizer component 254 to determine a lead score for each product and coverage recommendations, as explained in detail herein.

In some embodiments, lead scoring component 250 may be configured to determine the lead score based on one or more analytical techniques, and one or more datasets. In some embodiments, scoring machine learning component 252 may be configured to use one or more of a deep learning model, a logistic regression model, a Long Short Term Memory (LSTM) network, supervised or unsupervised model, etc. In some embodiments, scoring machine learning component 252 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques. For example, component 250 may obtain online behavior information associated with the user submitting the coverage recommendation request. In some embodiments, user online behavior may be used to determine user insurance needs. For example, a customer who relies on the online chat feature may value personal service over price. For those customers, the lead scoring component 250 may calculate a higher lead score on product and coverage by a carrier that provides a higher level of customer service at a higher price.

Similarly, a customer that spent more time interacting with the multi-carrier coverage recommendation application (e.g., client application 167 running on client computing device 160 illustrated in FIG. 1) is more likely to need immediate insurance coverage than a customer who spent only minimal time and/or was not very active on the website (e.g., activity may be expressed as a number of hits or number of submissions). Accordingly, the lead scoring component 250 may calculate a higher lead score for product and coverage recommendations for that user relative to others. In some embodiments, a customer's preferred way of being contacted may be indicative of their needs. For example, a customer who wished to be contacted by phone is likely very interested in insurance coverage than a customer who did not provide a contact number.

In some embodiments, module 250 would determine a lead score that may be used by insurance agents when determining which prospective customers are more likely to purchase product and coverage. In some embodiments, the scoring component 252 may apply machine learning techniques on historical data (e.g., data stored in historical claim database 212) and carrier data (e.g., data stored in carrier database 206), among other suitable databases to identify factors that may assist in determining which recommendations are likely to be converted into actual purchases. For example, the scoring component 252 may use historical claim data to identify which loss factors that could have been prevented with proper coverage. Alternatively, additional data sets, e.g., agency database configured to store agency historic closing data, overall book of business risk exposure, risk of retention loss, conversion rate data, among other data may be used by component 252 when determining a lead score for a particular recommendation.

In some embodiments, the optimizer component 254 may include a processor and a memory, the memory having instructions stored thereon that cause the processor to optimize the scoring machine learning component 252 according to, e.g., an error of the determined lead score. In some embodiments, the optimizer component 254 may determine an error associated reach recommended product with a high lead score as compared to the actually purchased product by the user. For example, the recommendations with a high lead score that did not result in purchase would be identified by the optimizer component for further training of the 252 component. The optimizer component 254 may train the scoring machine learning component 252 according to the error resulting from each lead score determination.

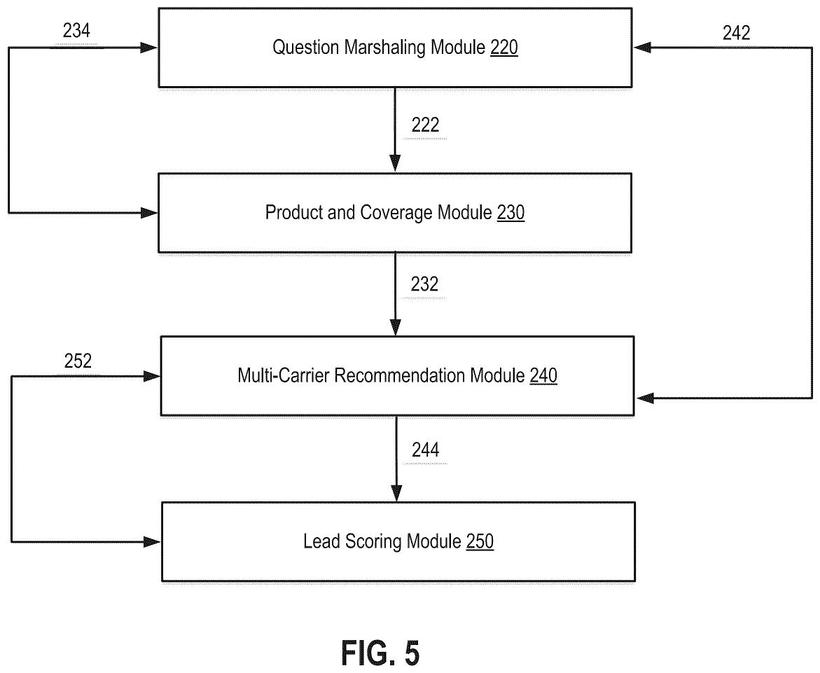

In some embodiments, modules 220-250 may be configured to operate simultaneously or in parallel and cause the output of each module to be dynamically adjusted. FIG. 5 illustrates the operation of marshalling module 220, product and coverage module 230, the multi-carrier recommendation module 240, and the lead scoring module 250. For example, in step 222 of marshalling module 220 may generate a set of user-specific questions the responses to which are utilized by product and coverage module 230. As module 230 identifies potential product and coverage recommendations in step 234, module 220 dynamically updates user-specific questions by continuously performing step 222, as described above. Next, product and coverage module 230 transmits the product and carrier determinations in step 232 to multi-carrier recommendation module 240. Similarly, as multi-carrier recommendation module 240 identifies potential carriers in step 242, module 220 dynamically updates user-specific questions by continuously performing step 222, as described above. The user provided responses to the adjusted or updated user-specific questions are continuously evaluated against the underwriting criteria thereby resulting in carriers being eliminated. That is, carriers whose underwriting criteria has not been satisfied by the user provided responses to the dynamically adjusted user-specific questions are eliminated, i.e., not considered by the multi-carrier recommendation module 240. Finally, the multi-carrier recommendation module 240 generates the carrier-specific product and coverage recommendations based on the carrier-specific products and coverages determinations and transmits them to lead scoring module 250 in step 244. As, the lead scoring module 250 determines the lead score for each recommendation, the multi-carrier recommendation module 240 dynamically adjusts or updates the recommendations in accordance with the lead score received from lead scoring module 250.

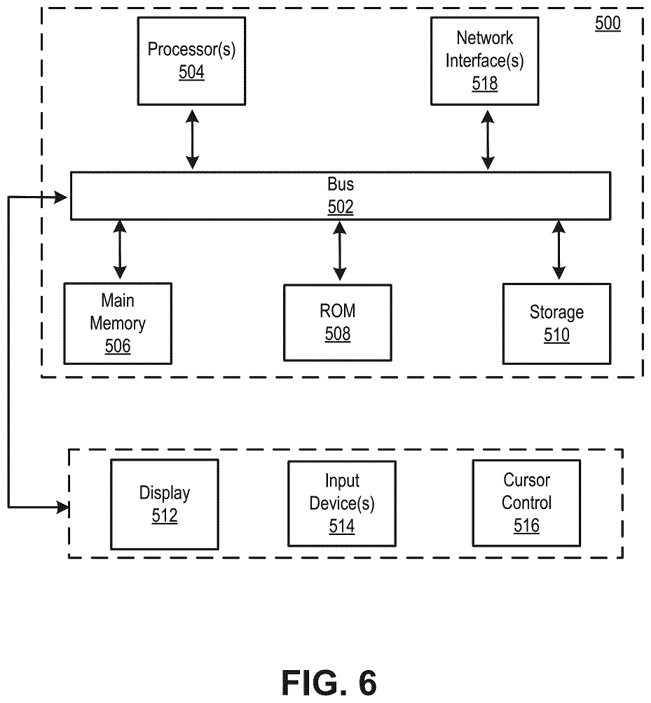

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, Javascript, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (Saas). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method for dynamically adjusting user-specific underwriting information, the method comprising:
generating a set of master question answers based on underwriting information associated with a plurality of carriers, the set of master question answers comprising a first set of carrier-neutral question answers and a second set of carrier-specific question answers;
determining a plurality of product and coverage recommendations based on user provided responses to the first set of question answers;
determining a plurality of carriers providing carrier-specific products and coverages corresponding to the plurality of product and coverage recommendations;
generating a user-specific set of question answers by mapping underwriting information associated with the plurality of carriers determined to provide carrier-specific products and coverages to the second set of carrier-specific question answers;
dynamically adjusting the plurality of carriers providing carrier-specific products and coverages based on user provided responses to the user-specific set of question answers; and
in parallel with dynamically adjusting the plurality of carriers providing carrier-specific products and coverages:
dynamically adjusting the user-specific set of question answers by eliminating question answers associated with the underwriting information associated with the plurality of carriers that have been eliminated.

2. The method of claim 1, wherein the user provided responses to the first set of question answers and user and the user provided responses to the user-specific set of question answers comprise business information associated with a business entity.

3. The method of claim 2, wherein the machine-readable storage medium storing instructions that, when executed by the one or more processors, further cause system to:
determining a business type of the business entity based on the business information of the business entity;
obtaining historical incident information for a plurality of business entities associated with the determined business type, wherein the historical incident information comprises a plurality of historical incidents that have adversely affected the plurality of business entities; and
determining a likelihood of occurrence of one or more incidents that adversely impact the business entity based upon the business information of the business entity and the historical incident information.

4. The method of claim 3, wherein the determined plurality of product and coverage recommendations mitigate the likelihood of occurrence of the one or more incidents adversely impacting the business entity.

5. The method of claim 1, wherein the underwriting information associated with the plurality of carriers comprises underwriting criteria used by the plurality of carriers to determine eligibility.

6. The method of claim 5, wherein the underwriting criteria comprises a plurality of underwriting questions associated with the plurality of carriers.

7. The method of claim 6, wherein dynamically adjusting the plurality of carriers providing carrier-specific products and coverages comprises identifying carriers with the underwriting criteria satisfied by the user provided responses to the user-specific set of question answers, and wherein the carriers with the underwriting criteria not satisfied by the user provided responses to the user-specific set of question answers are eliminated.

8. The method of claim 6, wherein a user-specific question answer of the user-specific set of question answers may be associated with at least two underwriting questions of the underwriting information associated with at least two carriers, wherein the underwriting information associated with the at least two carriers is mapped to the same question answer of the second set of carrier-specific question answers.

9. The method of claim 6, wherein the machine-readable storage medium storing instructions that, when executed by the one or more processors, further cause system to:
applying one or more deep learning systems to the underwriting information associated with the plurality of carriers to extract feature representations from the at least one underwriting question, wherein the feature representations comprise one or more feature; and
using one or more machine learning models to predict at least one of the carrier-specific question answers for the at least one underwriting question based at least on the feature representations and generate a prediction confidence of the carrier-specific question answers, wherein the one or more machine learning models comprise at least one of a natural language processing (NLP) model.

10. The method of claim 1, wherein the machine-readable storage medium storing instructions that, when executed by the one or more processors, further cause system to:
identifying at least one knock-out question within the underwriting information of the plurality of carriers determined to provide carrier-specific products and coverages, wherein the at least one knock-out question is associated with an underwriting risk factor; and
determining order of the user-specific set of question answers based on the knock-out questions.

11. The method of claim 1, wherein the machine-readable storage medium storing instructions that, when executed by the one or more processors, further cause system to:
generating a plurality of carrier-specific product and coverage recommendations based on the plurality of carriers providing carrier-specific products and coverages determined in response to dynamically adjusting the user provided responses to the user-specific set of question answers.

12. A system comprising:
one or more computing processors; and
a machine-readable storage medium storing instructions that, when executed by the one or more processors, cause the system to:
generate a set of master question answers based on underwriting information associated with a plurality of carriers, the set of master question answers comprising a first set of carrier-neutral question answers and a second set of carrier-specific question answers;
determine a plurality of product and coverage recommendations based on user provided responses to the first set of question answers;
determine a plurality of carriers providing carrier-specific products and coverages corresponding to the plurality of product and coverage recommendations;
generate a user-specific set of question answers by mapping underwriting information associated with the plurality of carriers determined to provide carrier-specific products and coverages to the second set of carrier-specific question answers;
dynamically adjust the plurality of carriers providing carrier-specific products and coverages based on user provided responses to the user-specific set of question answers; and
in parallel with dynamically adjusting the plurality of carriers providing carrier-specific products and coverages:
dynamically adjust the user-specific set of question answers by eliminating question answers associated with the underwriting information associated with the plurality of carriers that have been eliminated.

13. The system of claim 12, wherein the user provided responses to the first set of question answers and user and the user provided responses to the user-specific set of question answers comprise business information associated with a business entity.

14. The system of claim 13, wherein the machine-readable storage medium storing instructions that, when executed by the one or more processors, further cause system to:
determine a business type of the business entity based on the business information of the business entity;
obtain historical incident information for a plurality of business entities associated with the determined business type, wherein the historical incident information comprises a plurality of historical incidents that have adversely affected the plurality of business entities; and
determine a likelihood of occurrence of one or more incidents that adversely impact the business entity based upon the business information of the business entity and the historical incident information.

15. The system of claim 14, wherein the determined plurality of product and coverage recommendations mitigate the likelihood of occurrence of the one or more incidents adversely impacting the business entity.

16. The system of claim 12, wherein the underwriting information associated with the plurality of carriers comprises underwriting criteria used by the plurality of carriers to determine eligibility.

17. The system of claim 16, wherein the underwriting criteria comprises a plurality of underwriting questions associated with the plurality of carriers.

18. The system of claim 17, wherein dynamically adjusting the plurality of carriers providing carrier-specific products and coverages comprises identifying carriers with the underwriting criteria satisfied by the user provided responses to the user-specific set of question answers, and wherein the carriers with the underwriting criteria not satisfied by the user provided responses to the user-specific set of question answers are eliminated.

19. The system of claim 17, wherein a user-specific question answer of the user-specific set of question answers may be associated with at least two underwriting questions of the underwriting information associated with at least two carriers, wherein the underwriting information associated with the at least two carriers is mapped to the same question answer of the second set of carrier-specific question answers.

20. The system of claim 17, wherein the machine-readable storage medium storing instructions that, when executed by the one or more processors, further cause system to:
apply one or more deep learning systems to the underwriting information associated with the plurality of carriers to extract feature representations from the at least one underwriting question, wherein the feature representations comprise one or more feature; and
using one or more machine learning models to predict at least one of the carrier-specific question answers for the at least one underwriting question based at least on the feature representations and generate a prediction confidence of the carrier-specific question answers, wherein the one or more machine learning models comprise at least one of a natural language processing (NLP) model.

21. The system of claim 12, wherein the machine-readable storage medium storing instructions that, when executed by the one or more processors, further cause system to:
identify at least one knock-out question within the underwriting information of the plurality of carriers determined to provide carrier-specific products and coverages, wherein the at least one knock-out question is associated with an underwriting risk factor; and
determine order of the user-specific set of question answers based on the knock-out questions.

22. The system of claim 1, wherein the machine-readable storage medium storing instructions that, when executed by the one or more processors, further cause system to:
generate a plurality of carrier-specific product and coverage recommendations based on the plurality of carriers providing carrier-specific products and coverages determined in response to dynamically adjusting the user provided responses to the user-specific set of question answers.
